(19) United States
(12) Patent Application Publication
(10) Pub. No.: US 2009/0099687 A1
(43) Pub. Date: Apr. 16, 2009

(54) Method and apparatus for continuous motion tipping of tip-on products onto continuously moving base products

(75) Inventors: Peter M. Nordling, Grant, MN (US); Ryan M. Helgeson, Stillwater, MN (US)

Correspondence Address: NIKOLAI & MERSEREAU, P.A., 900 SECOND AVENUE SOUTH, SUITE 820, MINNEAPOLIS, MN, 55402, US

(73) Assignee: Multifeeder Technology, Inc., White Bear Lake, MN (US)

(21) Appl. No.: 11/904,076

(22) Filed: Sep. 25, 2007

Related U.S. Application Data
(63) Continuation of application No. PCT/US06/11274, filed on Mar. 28, 2006.
(60) Provisional application No. 60/665,709, filed on Mar. 28, 2005.
(60) Provisional application No. 60/715,282, filed on Sep. 8, 2005.

(51) Int. Cl. G06F 17/00

(52) U.S. Cl. 700/230

(57) ABSTRACT

A method and apparatus to facilitate accurately matching and placing non-uniformly spaced tip-on products from a friction feeder onto non-uniformly spaced base products that are traveling on a base conveyor while both the friction feeder and the base conveyor are continuously moving. Using encoders on the conveyor drive motors to track conveyor position and electronic sensors to detect the arrival on tip-on products and base products at predetermined points along their respective conveyors, a programmed microcontroller implements an algorithm for adjusting the speed of the sheet feeder's discharge conveyor so that the tip-on product and base product arrive at a matchpoint simultaneously.

### CROSS REFERENCE TO RELATED APPLICATIONS

This application is a Continuation-in-Part of Provisional Patent Application Ser. No. 60/665,709, filed Mar. 28, 2005, and of Provisional Patent Application Ser. No. 60/715,282, filed Sep. 8, 2005, each of which applications are hereby incorporated by reference.

### BACKGROUND OF THE INVENTION

1. Field of the Invention

This invention relates generally to apparatus for affixing a label or other type of tip-on onto base products as they traverse a base conveyor, and more particularly to a system for placing tip-on products onto base products (tipping) by traversing a continuously moving base conveyor from a processor-controlled sheet feeder.

2. Discussion of the Prior Art

Friction sheet feeders are known in the art and are commonly used in printers, plain paper copiers, and the like to feed individual sheets, one at a time, from a stack of such sheets into a printer or copy machine. Friction feeders have also been used in mass mailing applications for assembling and collating packages of sheet materials between flights of a conveyor leading to a high speed wrapper.

It is important in such applications that the friction feeder delivers products, one at a time, in synchronized relation to the operation of associated equipment accurately, reliably, and repeatively. For example, in the mass mailing application, a plurality of friction feeders are arranged along a length of a transversely extending belt conveyor and each such friction feeder must deliver only one article at a time from its stack onto the conveyor as each defined flight thereof passes the discharge end of the friction feeder. The friction feeders must therefore operate reliably, at high speeds, over prolonged periods and with a minimum of operator intervention for clearing jams or multiple feeds.

A friction feeder admirably suited for this type of duty is described in the Vedoy et al. U.S. Pat. No. 6,050,563, the contents of which are hereby incorporated by reference as if set forth fully herein. The Vedoy '563 patent describes in detail how sheet-like articles contained in a stack or hopper can be delivered, one at a time, by way of a discharge conveyor whose speed is electronically controlled via a microprocessor-based motor control circuit.

In performing a “tipping” operation, a sheet feeder is made to place a sheet-like tag or label onto a base product as the base product traverses a base conveyor. It is often a requirement that the tag or label (hereinafter referred to as a “tip-on product”) be placed at a location on the base product with a high degree of placement accuracy.

The prior art friction feeders have been made to operate in a start-then-stop mode referred to as “indexing”. The indexed or step-by-step mode inefficiently moves the tip-on product from the feeder to the conveyor. The use of indexing constitutes a trade-off of overall product throughput for more consistent placement accuracy. When the feeder stops on the next base product, it will stop at a specific spot on that product. This allows the feeder to have a consistent distance to travel prior to placing the tip-on product on the base conveyor product. Typical prior art friction feeders use indexing because the product separation on the feeder discharge conveyor is not uniform due to the use of friction to separate the products from the bottom of the stack.

Other known prior art tipping systems that continuously move require the use of mechanical mechanisms, e.g., chains, lugs, etc., to keep the tipping machine's discharge synchronized with the movement of the base conveyor. In addition, on such systems, the products may require a uniform product separation for the tip-on product and base product to remain synchronized.

It is accordingly a principal object of the present invention to provide a system and method to facilitate accurately matching and placing non-uniformly spaced tip-on products from a friction feeder onto non-uniformly spaced base products that are traveling on a base conveyor while both the feeder and the conveyor are continuously moving.

Another object of the invention is to provide a system of the type described that is capable of running at substantially higher rates of throughput than known prior art indexing-based tipping systems.

Yet another object of the invention is to provide a system of the type described that imposes less wear and tear on the equipment than a conventional indexing system as well as less wear and tear on products being handled in that each product is subject to less friction due to lower accelerations and decelerations.

### SUMMARY OF THE INVENTION

The foregoing features, objects and advantages of the invention are attained by providing a motor-driven endless belt conveyor having a first encoder coupled to said motor that provides base conveyor positional information as it transports base products on the conveyor. A motor-driven sheet feeder is provided for delivering individual tip-on products from a stack to a discharge conveyor where the discharge conveyor has an outlet end positioned above the endless belt of the base conveyor at a matchpoint location on the base conveyor. The motor of the motor-driven sheet feeder also has an encoder for providing discharge conveyor positional information. A base product sensor is positioned relative to the base conveyor for detecting the arrival of base products at a predetermined point on the base conveyor and producing a signal relating to the detected event. Similarly, a tip-on product sensor is positioned relative to the discharge conveyor of the sheet feeder for detecting the arrival of tip-on products at a predetermined point on the discharge conveyor and producing a signal relating thereto. Completing the tipping system is an electronically-controlled programmable processor that is coupled to receive as inputs the base conveyor positional information, the discharge conveyor positional information, the signal from the base product sensor, and the signal from the tip-on product sensor and where the processor is programmed for generating a motor control signal to continuously adjust the velocity of the discharge conveyor so that a base product and the tip-on product arrive at the matchpoint location simultaneously.

In accordance with a further aspect of the invention, a second-stage discharge conveyor may be positioned between the discharge conveyor of the sheet feeder and the selected matchpoint on the base conveyor where the second stage discharge conveyor also incorporates a microprocessor-based motor control circuit including an encoder and a tip-on product sensor and where the controller's microprocessor is also programmed to implement a PID loop. The use of the optional second stage conveyor provides even greater precision in the placement of tip-ons on base products and at significantly higher rates than can be achieved by prior art systems where indexing or other mechanical mechanisms are used to maintain synchronization.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which:

FIG. 1 is a schematic mechanical drawing of a tipping system constructed in accordance with the present invention;

FIG. 2 is a drawing like that of FIG. 1 but reflecting a different positional spacing between base products;

FIG. 3 is a flow chart of the basic control logic algorithm used in implementing the present invention; and

FIG. 4 is a schematic mechanical/electrical diagram of a continuous tipping system having a dual stage discharge conveyor.

### DESCRIPTION OF THE PREFERRED EMBODIMENT

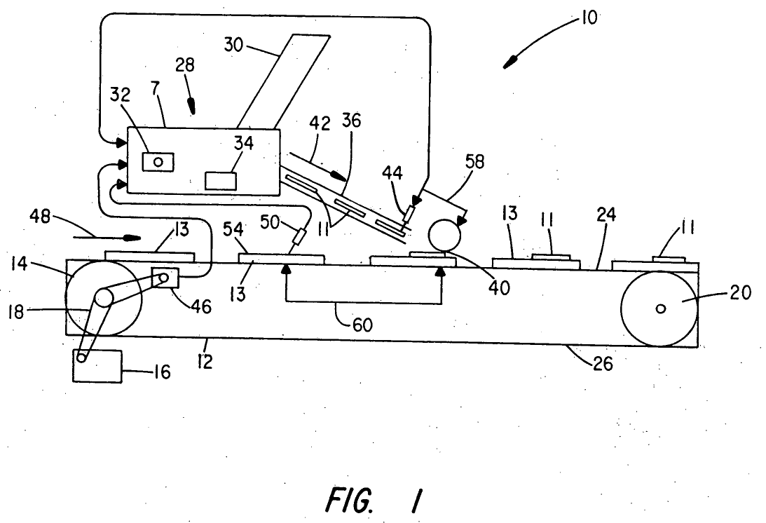

Referring first to FIG. 1, there is indicated generally by numeral 10 an apparatus for accurately placing a tip-on product 11 onto a base product 13 at a predetermined location on the base product with a high degree of positional accuracy. The system is seen to comprise an endless-belt base conveyor 12 having a drive roller 14 driven by a motor 16, via a chain, smooth belt or toothed belt 18. The conveyor 12 has a driven nose roller 20 and an endless base-conveyor belt or lugged conveyor belt that extends about the drive roller 14 and the nose roller 20 to define an upper belt flight 24 and a lower belt flight 26. Without limitation, the base conveyor can be a standard belted machine with non-uniform spaced products or, alternatively, can be a lugged conveyor providing somewhat uniform product spacing. The present invention could also be employed to apply tip-ons to base products comprising a continuous web of product that is moving from a source roll to a take-up roll.

Appropriately mounted above the upper flight 24 of the base conveyor 12 is a sheet feeder, indicated generally by numeral 28. In implementing a preferred embodiment of the present invention, the sheet feeder 28 may comprise the electromechanical friction feeder Model MFT 250 IP manufactured and sold by Multifeeder Technology, Inc. of Saint Paul, Minn., that device being more particularly described in the aforereferenced Vedoy et al. U.S. Pat. No. 6,050,563. It should be understood, however, that other commercially-available sheet feeders may also be configured to operate in accordance with the teachings of the present invention such that limitation to that Multifeeder Technology, Inc. product should not be inferred.

As is indicated in the schematic diagram of FIG. 1, the sheet feeder 28 includes a hopper 30 for containing a stack of tip-on products 11. Built into the sheet feeder 28 are motor-driven stripper wheels, the rotation of which is governed by a servo motor 32 that, in turn, is controlled by a microprocessor-based controller 34 so as to deliver tip-on products 11 between adjacent, cooperating flights of upper and lower endless belts of a discharge conveyor 36 that in the embodiment of FIG. 1 is used to transport tip-on products 11 to a desired point along the base conveyor flight 24 termed the “matchpoint”. In FIG. 1, the matchpoint is identified by numeral 40. While it is contemplated that the microprocessor-based controller 34 already resident in the MFT 250 IP may be used to execute the software implementing the discharge conveyor speed control to effect continuous tipping operations, those skilled in the art will appreciate that this same software could be run on a microprocessor external to the feeder. Moreover, the invention can be implemented using a programmable logic controller (PLC) disposed either within the sheet feeding machine or externally to it.

The position of the belts comprising the discharge conveyor is tracked by an encoder linked to the servo motor 32 and that positional information, along with clock signals for the microprocessor-based controller 34, are used to establish the velocity of the discharge conveyor and represented by the VELOCITY_A (vector 42 in FIG. 1).

Also associated with the discharge conveyor 36 is an electronic position sensor 44 that is adapted to provide a signal back to the microprocessor-based controller 34 upon the arrival of a tip-on product 11 at a predetermined point along the length of the discharge conveyor 36.

In a similar fashion, the position of the base conveyor 12 has an encoder 46 whose output is provided to the microprocessor-based controller 34 allowing a computation to be made of the velocity of the base conveyor 12 as represented by the VELOCITY_B (vector 48).

An electronic position sensor 50 is disposed in proximity to the upper flight 24 of the base conveyor 12 to detect and provide a signal to the microprocessor in the sheet feeder 28 upon the arrival of a base product 13 at a predetermined point along the length of the base conveyor.

In FIG. 1, the distance between the tip-on product sensor 44 and the matchpoint may be referred to as SENSOR_LEN_A and is identified by bracket 58. Similarly, the distance between the base product sensor 50 and the matchpoint is referred to in the following equations as: SENSOR_LEN_B and is identified by bracket 60.

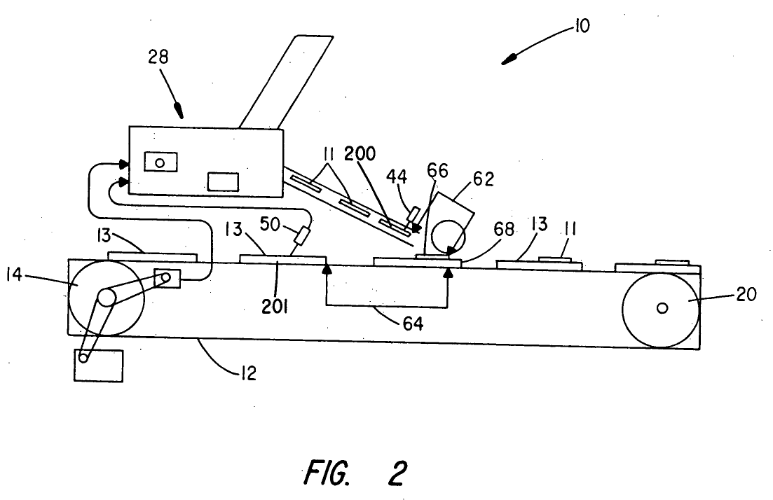

In FIG. 2, the meeting of the tip-on product 11 with the base product 13 at the matchpoint involves tip-product identified by numeral 66 and base product 68.

In order to accurately place the tip-on product on a target base product, the feeder discharge conveyor 36 must travel at a speed (VELOCITY_A) that will insure that the currently active tip-on product 200 reaches the matchpoint position at exactly the same time as the currently active base product 201 reaches the matchpoint position. The algorithm executed by the microprocessor in the sheet feeder 28 determines the ideal velocity for the discharge conveyor using the following formula:

VELOCITY_{—}A=VELOCITY_{—}B*(DELTA_{—}A/DELTA_{—}B)

where DELTA is the distance 62 between the leading edge of the currently active tip-on product and the matchpoint and DELTA_B is the distance 64 between the currently active base product 13 and the matchpoint. Any changes in the base conveyor velocity (VELOCITY_B) require a recalculation of the ideal feeder discharge conveyor velocity to insure that VELOCITY_A remains correct. In practice, it has been found that it is unnecessary to recalculate the DELTA_A and the DELTA_B values in the VELOCITY_A calculation after the initial calculation for the current “active” products. As used herein, “active” products is used to signify the particular products that are next in line to meet up with the matchpoint in that they are “active” in the software calculations.

Under certain conditions, a periodic recalculation may provide some optimization benefits, especially if there is significant initial error resulting from start-up conditions, but it is more important to regularly update VELOCITY_A for changes in VELOCITY_B. When the active tip-on product and base product have reached the matchpoint, it is appropriate to recalculate VELOCITY_A and DELTA_B values of the next active product.

Even though VELOCITY_A of the discharge conveyor 36 is determined to have matched that of the base conveyor 12 exactly, the discharge conveyor 36 will incur some positional error due to the magnitude of the change in discharge conveyor speed, the load on the system, base conveyor changes in speed, etc. In addition, if there is a significant change in speed, the time it takes for the discharge conveyor to accelerate or decelerate to the new speed may result in a significant error. In accordance with the present invention, however, this error is effectively removed with the implementation of a PID loop calculation. As those skilled in the art appreciate, PID calculations are commonly used with motion controllers, programmable logic controllers (PLCs) and motors. The PID controller compares a measured value from a process with a reference setpoint value. The difference or “error” signal is then processed to calculate a new value for a manipulated process input, which new value brings the process measured value back to its desired setpoint. In implementing a PID loop, the microprocessor 34 in the sheet feeder 28 obtains a calculated error and then adjusts the output based on the error to affect the result in a way that reduces or eliminates the error.

In accordance with the present invention, the error is calculated by taking the current discharge conveyor position by means of the encoder 32 and subtracting the initial discharge conveyor position which may be referred to as CURRENT_A and INITIAL_A which creates a difference (DIFF_A). Next, the current base conveyor position determined by the encoder 46 is subtracted from the initial base conveyor position, INITIAL_B, and this creates a difference referred to as DIFF_B. Using these differences, along with DELTA_A and DELTA_B, a target position can be constructed for the feeder discharge conveyor to use called TARGET_A. The error is calculated using the difference between the discharge conveyor's target position and DIFF_A. That is:

DIFF_{—}A=CURRENT_{—}A−INITIAL_{—}A

DIFF_{—}B=CURRENT_{—}B−INITIAL_{—}B

TARGET_{—}A=DIFF_{—}B*(DELTA_{—}A/DELTA_{—}B)

CURRENT_ERROR=TARGET_{—}A−DIFF_{—}A

PID_VELOCITY_ADJUSTMENT=PID_CALCULATION(CURRENT_ERROR)

The PID routine, itself, takes this error and calculates a velocity adjustment factor. As those skilled in the art appreciate, the tuning of a PID routine is highly dependent upon the system in question. The motor, amplifier, update period, inertial mass of the system, friction, etc., all assert an influence upon the fine tuning of the PID variables. PID tuning and loop optimization software are commercially available and are preferably used to ensure consistent results. Such software packages will gather the data, develop process models and suggest optimal tuning. For the purposes of the present invention, this generic software procedure is referred to as the “PID_CALCULATION”. Thus:

PID_VELOCITY_ADJUSTMENT=PID_CALCULATION(CURRENT_ERROR)TOTAL_VELOCITY=VELOCITY_{—}A+PID_VELOCITY_ADJUSTMENT

The feeder's controller with adjust the discharge conveyor velocity to the TOTAL_VELOCITY.

The algorithm is such that TOTAL_VELOCITY remains a positive quantity in that friction feeders generally do not function properly when they are run in reverse. Should the calculation produce a negative quantity, the sheet feeder is made to wait until the base conveyor catches up at which point the TOTAL_VELOCITY goes positive again.

We have determined that it is possible to use only the PID_VELOCITY ADJUSTMENT in the TOTAL_VELOCITY calculation if desired. This has the advantage of producing a simpler calculation. However, that leads to a less robust system, which requires increasing the fine tuning of the PID routine. In this case, the TOTAL_VELOCITY equation reduces to:

TOTAL_VELOCITY=PID_VELOCITY ADJUSTMENT

As is shown in FIGS. 1 and 2, when the current base product has gone beyond the desired tip-on position under the matchpoint 40 and when the leading edge of the current tip-on product has reached the matchpoint, a new discharge conveyor velocity is calculated based on both the base conveyor velocity and the current distances to the matchpoint for both the discharge conveyor 62 and base conveyor 64. At this time, the error calculations for the PID routines are reset and new INITIAL values and DELTA values are set.

Should it happen that there is no current base product available on the base conveyor, the feeder 28 is programmed to come to a stop and wait until a base product is detected by the sensor 50. When a new product does appear, the sheet feeder will resume calculations. If this is a common occurrence and the machine operator does not wish for the feeder to stop, the operator can move the sensor 50 farther upstream so that it is more likely to have products in a software queue. Should it happen that there is no tip-on product available on the feeder's discharge conveyor, the feeder is made to continuously run at a matching speed with the base conveyor until a new tip-on product appears, whereupon the calculations are made to resume. Here, it may be advantageous to temporarily increase the speed of the sheet feeder 28 in order to load the next tip-on product onto the discharge conveyor more quickly.

Should it be found that there is a considerable variation in product separation on the discharge conveyor 36, and the machine operator desires more consistency, he/she can move the sensor 44 farther upstream on the discharge conveyor so that it is more likely to have products in the software queue.

It is also contemplated that the software controlling the sheet feeder 28 may incorporate a watch-dog calculation that will come into play should the feeder run out of tip-on products. The watch-dog routine can trigger an interrupt fault stopping the system and alerting the operator that the hopper 30 must be reloaded.

The acceleration and deceleration constants used in the embodiment of FIG. 1 are also highly dependent on the target system. While a high rate of acceleration can help the apparatus achieve the target speed initially and will insure that the feeder 28 does not fall behind the delivery of products by the base conveyor 12, this can become a problem if the base conveyor is traveling at an extremely high velocity. However, too high of an acceleration can potentially destabilize the system and produce inadequate placement of the tip-on product relative to the base product in that the controller 34 can apply too much power to the motor 32 too quickly. An adaptive technique that allows high initial accelerations and decelerations, but lowers to an acceptable level after the feeder discharge conveyor 36 has caught up to the base conveyor addresses this issue. If such an adaptive technique is not employed, the acceleration should be set just high enough to allow the feeder discharge conveyor 36 to catch up with the base conveyor regardless of the base conveyor's running speed.

### First Alternative Embodiment

### Speed and Position Match

Instead of having the sheet feeder 28 adjust its speed so that the given distance traveled is proportional to the location of the product on the base conveyor 12, in accordance with an alternative embodiment, a velocity of the underlying conveyor and the position at the matchpoint are synchronized. To accomplish this, the speed of the discharge conveyor VELOCITY_A (vector 42) is modified to match the speed of the conveyor VELOCITY_B (vector 48) as exactly as possible.

This speed matching approach differs from the earlier described embodiment in that there is no proportion multiplied against the conveyor velocity (VELOCITY_B). Instead, it is assigned directly to the feeder velocity (VELOCITY_A). That is:

VELOCITY_A=VELOCITY_B

Another difference in this alternative embodiment from that earlier described involves the PID ERROR CALCULATION. The PID calculation of the speed in the embodiment now being described uses an error calculation that is modified to reference the difference between the true distance to the matchpoint instead of a proportional distance to the matchpoint.

In the following equations, DISTANCE_A refers to the distance between the active product on the feeder's discharge conveyor to the matchpoint and DISTANCE_B refers to the base conveyor's product distance to the matchpoint. The CURRENT_ERROR referenced in the PID calculation is the difference between the base conveyor and discharge conveyor distances. Hence,

DISTANCE_{—}A=CURRENT_{—}A−INTIAL_{—}A

DISTANCE_{—}B=CURRENT_{—}B−INITIAL_{—}B

CURRENT_ERROR=DISTANCE_{—}B−DISTANCE_{—}A

PID_VELOCITY_ADJUSTMENT=PID_CALCULATION(CURRENT_ERROR)]

The PID routine itself takes this error and calculates a velocity adjustment. Those skilled in the art appreciate that the tuning of a PID routine is highly dependent upon the system in question. The motor, amplifier, update period, initial mass of the system, friction, etc. all assert an influence upon the fine tuning of the PID variables. For convenience, the generic software procedure is referred to herein as the PID_CALCULATION. Thus:

PID_VELOCITY_ADJUSTMENT=PID_CALCULATION(CURRENT_ERROR)TOTAL_VELOCITY=VELOCITY_{—}A+PID_VELOCITY ADJUSTMENT

As indicated earlier, it is useful to cut off the TOTAL_VELOCITY at zero when TOTAL_VELOCITY is computed to be less than zero in that friction feeders are not designed to run in reverse. Here, the friction feeder is made to wait until the base conveyor catches up and the TOTAL_VELOCITY goes positive again.

In practice, the error will usually be a maximum in the beginning of a new cycle. If the repeat distance on the base conveyor is longer than the repeat distance between tip-on products on the discharge conveyor, the feeder will slow down or stop until the base conveyor can catch up. If the tip-on product repeat distance on the feeder discharge conveyor is longer than the repeat distance of base products, the feeder will accelerate to catch up to the base conveyor.

After the PID routine has removed the error, the sheet feeder will be speed matched to the base conveyor and running at the same speed as the base conveyor for the remaining distance to the matchpoint. The advantage to this is that the tip-on product will often be placed more effectively when it is traveling at the same rate as the underlying base product. The disadvantage to this is that for small products onto a large base product the feeder would need to go into intermittent motion, reducing throughput.

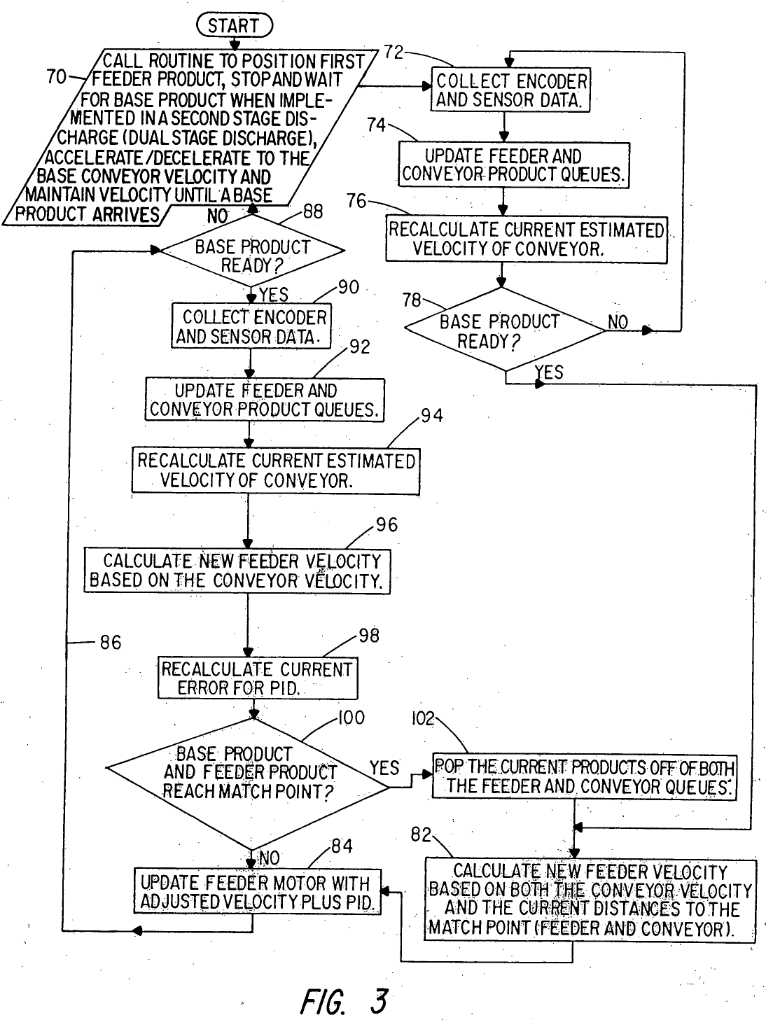

Turning next to FIG. 3, there is presented a software flow chart of the algorithm executed by the microprocessor 34 that may be located within the sheet feeder 28 or external to it, whereby the tip-on product is moving at the same velocity at the matchpoint as the base conveyor product. At start-up, a routine stored in the memory of the microprocessor 34 is called to position a first feeder product, i.e., a tip-on product on the discharge conveyor 36. The discharge conveyor is then stopped and allowed to wait for a base product to arrive at a predetermined point on the base conveyor 12 as determined by the base product sensor 50. See box 70 in FIG. 3. Next, data is collected from encoders 32 and 46 whereby the relative position of the discharge conveyor belts and the base conveyor belt are established. See block 72. Knowing a distance moved during time periods established by the microprocessor clock, velocity can be calculated. Next, as indicated by operation block 74, the feeder and the base conveyor product queues are updated and this operation is followed by a step of recalculating the current estimated velocity of the base conveyor as reflected in operation box 76.

Next, a test is made at decision block 78 to determine whether a base product has reached a predetermined point on the conveyor 12 as sensed by the base product sensor 50 and, if not, control loops back over path 80 back to block 72. If the test at decision block 78 indicates that a base product is ready, the operation reflected by box 82 is carried out. That is, a computation is made of what the new feeder discharge conveyor velocity must be, based on the velocity at which the base conveyor 12 is moving and the current distances to the matchpoint for both the feeder discharge conveyor 36 and the base conveyor 12. Next, the microprocessor in the motor control module 34 executes the PID routine and the resulting correction factor is applied to the calculated feeder velocity from step 82. See operation block 84. Control then loops over path 86 to decision block 88 where a test is made to determine whether the base product has reached a predetermined location on the base conveyor. Assuming that the base product is ready, data from the encoders 32 and 46 and from the product precision sensors 44 and 50 are collected (box 90). Steps 74 and 76 are then repeated at blocks 92 and 94, thus allowing a new feeder velocity value to be calculated based upon the then-current base conveyor velocity as reflected by operation block 96. The microprocessor then recalculates the current error established by the PID loop and the correction factor is applied to the feeder velocity as reflected by block 98.

Next, a test is made at decision block 100 to determine whether the base product and feeder product have reached the matchpoint. If so, the current tip-on product and base product are dropped from the feeder and base conveyor queues and the step reflected by operation block 82 is repeated for the next products in those queues. However, if the test at decision block 100 had indicated that both the base conveyor product and the tip-on product had not reached the matchpoint, the speed of the feeder motor would be updated (block 84) and operations would proceed as already described until the current tip-on product and base conveyor product arrive simultaneously at the matchpoint with the same velocity.

### Second Alternative Embodiment

### Dual Discharge

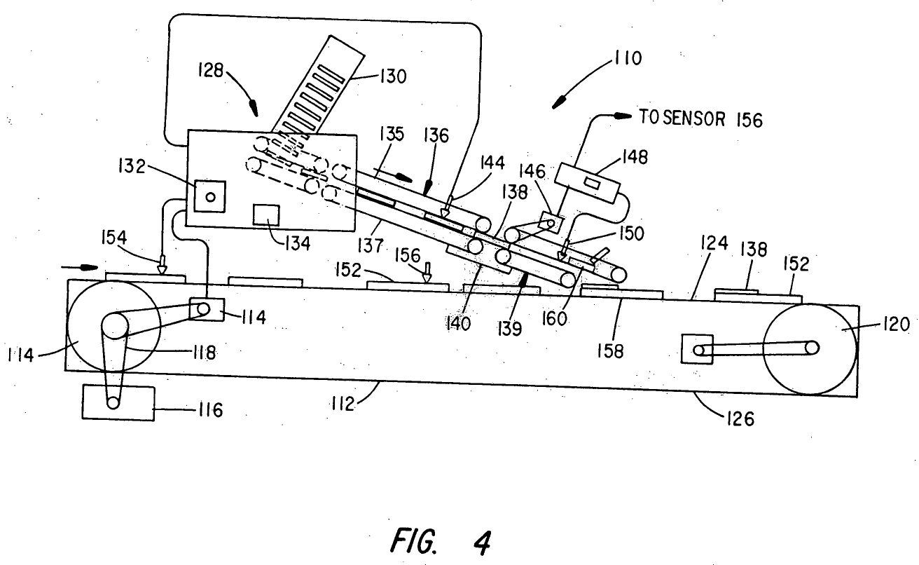

In an application where even greater control must be applied to the placement of the tip-on product to the base product, a secondary discharge can be installed in the system of FIG. 1 to create a second placement correction and PID calculation. This is essentially a second system in series with a primary system. The additional precision achieved by using the secondary discharge approach reflected in the drawing of FIG. 4 permits operations, such as inkjet printing, magnetic encoding and labeling to be applied to the tip-on product. Further, the speed of the base conveyor can be greatly increased without sacrificing placement accuracy.

Referring to FIG. 4, there is indicated generally by numeral 110, the system for affixing tip-on products onto a base product at a predetermined location on the base product at higher speeds and with even a greater degree of positional accuracy than may be achievable using the embodiments of FIGS. 1 and 2. The system depicted in FIG. 4 is also seen to comprise an endless belt base conveyor 112 having a drive roller 114 driven by a suitable motor 116 via a chain, a smooth belt or toothed belt 118. The base conveyor 112 has a driven nose roller 120 and an endless belt 122 extends about the drive roller 114 and the nose roller 120 to define an upper belt flight 124 and a lower belt flight 126.

Appropriately mounted above the upper flight 124 of the base conveyor 112 is a sheet feeder, indicated generally by numeral 128. In implementing the tip-on system of FIG. 4, the sheet feeder 128 preferably comprises the electromechanical friction feeder manufactured and sold by Multifeeder Technology, Inc. While that device is preferred, other commercially-available sheet feeders may be substituted.

As indicated in the schematic diagram of FIG. 4, the sheet feeder 128 includes a hopper 130 for containing a stack of tip-on products 138. As is more fully explained in the aforereferenced Vedoy et al. patent, the sheet feeder 128 incorporates motor-driven stripper wheels, the rotation of which is governed by a servo motor 132 that, in turn, is controlled by a microprocessor-based controller 134 so as to deliver tip-on products 138 between adjacent flights of an upper discharge belt 135 and a lower discharge belt 137 of a discharge conveyor 136.

Rather than using the discharge conveyor 136 to directly deliver tip-on products to a matchpoint on the upper flight 124 of the base conveyor 112, there is interposed between the distal end of the feeder discharge conveyor 136 and the matchpoint a second stage discharge conveyor indicated generally by numeral 139.

The second stage discharge conveyor 139 also incorporates a pair of motor-driven endless belts whose adjacently-positioned, cooperating flights move together in the same direction and are adapted to carry tip-on products 138 therebetween.

The feeder discharge conveyor 136 is mechanically joined to the second stage discharge conveyor 139 by means of a suitable mechanical bracket 140 that maintains a fixed distance between the output end of the feeder discharge conveyor 136 and the inlet end of the second stage discharge conveyor 139, that distance being set to the length of the tip-on products 138 from the tangent of the discharge roller of the feeder discharge to the tangent of the input roller of the secondary discharge or closer together than the length of the tip-on product 138.

Associated with the feeder's discharge conveyor 136 is a tip-on product position sensor 144. The output from this sensor is connected back to the microprocessor-based controller 134 and is effective to provide an output signal upon a tip-on product reaching the location of the sensor during its travel along the feeder's discharge conveyor 136.

With continued reference to FIG. 4, the motor used to drive the second stage discharge conveyor 139 is identified by numeral 146 and associated with that motor is an encoder module used to keep track of the relative position of the endless belts comprising the second stage discharge conveyor 139. Such encoders are a commercially available component. The motor 146 is controlled by a microprocessor-based controller 148 and receives as its inputs the output from the encoder 146 and a signal from a second tip-on product position sensor 150.

Base conveyor products 152 carried by the upper flight 124 of the base conveyor 112 are detected by sensors 154 and 156 upon their arrival at predetermined locations along the length of the base conveyor 112. Alternatively, a single detect sensor 154 can be used by both feeder controller 134 and secondary discharge controller 148 to simplify the system. The output signal from the sensor 154 is applied to the microprocessor-based controller 134 in the sheet feeder 128 while the output from the sensor 156 is applied to the controller 148 for the motor on the second stage discharge conveyor 139.

While tip-on products 138 could be directly delivered to the matchpoint 158 by the second stage discharge conveyor 139, it has been found expedient to utilize a vacuum transfer belt 160 to extend the reach of the second stage discharge conveyor 139 to the matchpoint 158. As those skilled in the art will appreciate, the vacuum transfer belt may incorporate a plurality of apertures and by maintaining a vacuum in a manifold spanned by the apertured belt, tip-on products can be made to adhere to the underside of the vacuum transfer belt 160 as they leave the interfacing adjacent flights of the secondary discharge conveyor 139.

Having described the constructional features of the embodiment of FIG. 4, its mode of operation will now be presented.

As previously indicated, the secondary discharge conveyor is powered by a servo motor 146 having associated therewith an encoder. The secondary discharge conveyor travels at a speed referred to as VELOCITY_A. The tip-on products are tracked by a microprocessor in the microprocessor-based controller 148 and by the electronic position sensor 150. The current tip-on product is being tracked at the discharge end of the discharge conveyor 136.

The base conveyor 112 is powered by the motor 116 and its encoder 119 provides positional feedback to the microprocessor-based controller 134 in the sheet feeder 128. The base conveyor moves at a speed referred to as VELOCITY_B. During normal operations, the secondary discharge conveyor 139 samples the line speed encoder 146 and the computer clock in the controller 148 to calculate VELOCITY_B.

The products on the base conveyor 112 are being tracked with an electronic sensor 156 that, combined with the encoder output of encoder 146, relates the position of the products on the base conveyor to the microprocessor-based controller 148.

The tip-on traveling on the secondary discharge conveyor 139 and base conveyor products meet at a location 158 called the matchpoint that is located beneath and tangent to the vacuum discharge exit. The distance between the secondary discharge sensor 150 and the matchpoint is referred to as SENSOR_LEN_A and the distance between the base conveyor sensor 156 and the matchpoint is referred to as SENSOR_LEN_B. The constant offset from the leading edge of the base product defining the target location for the tip-on product is referred to as TIPON_POSTION.

The distance between the leading edge of the current “active” tip-on product and the matchpoint is defined as DELTA_A. The distance between leading edge of the currently “active” base conveyor product and the matchpoint is defined as DELTA_B. As before, the term “active” does not signify movement. It instead is being used to signify that these are the products that are next in line to meet up with the matchpoint and they are “active” in the software.

The meeting of the two products at the matchpoint 158 is represented by the tip-on product 162 and the base conveyor product 164 in FIG. 4.

At all times on the base conveyor, there will be a distance between the currently active base product and the matchpoint, i.e., DELTA_B. At any time on the feeder discharge, there will be a distance between the currently active tip-on product and the matchpoint, which we have defined as DELTA_A.

In order to tip the product accurately, the second stage discharge needs to travel at a speed (VELOCITY_A) that will insure that the currently active tip-on product reaches the matchpoint position at exactly the same time as the currently active base product reaches the matchpoint position. The present invention determines the ideal velocity for the second stage discharge conveyor using the formula:

VELOCITY_{—}A=VELOCITY_{—}B*(DELTA_{—}A/DELTA_{—}B).

Changes in the base conveyor velocity (VELOCITY_B) require a recalculation of the ideal second stage discharge velocity to insure that VELOCITY_A stays correct. In practice, it is not necessary to recalculate the DELTA_A and DELTA_B values in the VELOCITY_A calculation after initial calculation for the current “active” products. In some situations, a recalculation can provide some optimization benefits, especially if there is extensive initial error resulting from a start-up condition, but it is more important to regularly update VELOCITY_A for changes in VELOCITY_B. When the currently “active” products on both the second stage discharge conveyor 139 and the base conveyor 112 have reached the matchpoint, it will again be time to recalculate VELOCITY_A with the next “active” product's DELTA_A and DELTA_B values.

Even though VELOCITY_A has been determined to match the base conveyor exactly, the second stage discharge conveyor may incur some positional error due to the magnitude of the change in the sheet feeder speed, the load on the system, base conveyor changes in speed, etc. In addition, if there is a significant change in speed, the time it takes for the secondary discharge conveyor to accelerate or decelerate to the new speed can incur a significant error.

In accordance with the present invention and as is well-known to persons skilled in the art, a PID loop calculation is employed to remove this error. The PID calculation takes a calculated error and then adjusts the output based on the error to affect the result in a way that reduces or eliminates the error. In the embodiment of FIG. 4, the error is calculated by taking the current position of the second stage discharge conveyor using its encoder 146 and subtracting from it the initial conveyor position which creates a difference referred to as DIFF_A. Likewise, the current base conveyor position is subtracted from the initial base conveyor position to create a difference referred to as DIFF_B. Using these two differences, along with DELTA_A and DELTA_B values previously defined, the target position for the second stage discharge conveyor to use can be constructed using the following equations. This is referred to as TARGET_A. The error is calculated using the differences between the target position and DIFF_A.

DIFF_{—}A=CURRENT_{—}A−INITIAL_{—}A

DIFF_{—}B=CURRENT_{—}B−INITIAL_{—}B

TARGET_{—}A=DIFF_{—}B*(DELTA_{—}A/DELTA_{—}B)

CURRENT_ERROR=TARGET_{—}A−DIFF_{—}A

PID_VELOCITY_ADUSTMENT=PID_CALCULATION(CURRENT_ERROR)

As with the earlier embodiment described, the PID routine takes this error and calculates a velocity adjustment. Persons skilled in the art are aware that tuning of a PID routine depends heavily upon the system in question. The particular motor, amplifier, the update period employed, the inertial mass of the system, friction coefficients, etc., all assert an influence upon the fine tuning of the PID variables. For purposes of the present invention, the generic software procedure is referred to as the PID_CALCULATION:

PID_VELOCITY_ADJUSTMENT=PID_CALCULATION(CURRENT_ERROR)TOTAL_VELOCITY=VELOCITY_{—}A+PID_VELOCITY_ADJUSTMENT

The variable, TOTAL_VELOCITY, is loaded into the microprocessor-based motion controller 148 and the second stage discharge conveyor will be made to accelerate or decelerate to the newly calculated speed.

The acceleration and deceleration constants used in the embodiment of FIG. 4 are also highly dependent on the target system. While a high rate of acceleration can help the apparatus achieve the target speed initially and will insure that the feeder 128 does not fall behind the delivery of products by the base conveyor 112, this can become a problem if the base conveyor is traveling at an extremely high velocity. However, too high of an acceleration can potentially destabilize the system and produce inadequate placement of the tip-on product relative to the base product in that the controller 148 may apply too much power to the motor 146 too quickly. An adaptive technique that allows high initial accelerations and decelerations, but lowers to an acceptable level after the second stage discharge conveyor has caught up to the base conveyor addresses this issue. If such an adaptive technique is not employed, the acceleration should be set just high enough to allow the second stage discharge conveyor 139 to catch up with the base conveyor regardless of the base conveyor's running speed.

For the dual discharge embodiment, the secondary discharge conveyor will accelerate/decelerate to the base conveyor line speed when waiting for the next base product to arrive for optimal performance.

### Third Alternative Embodiment

### Open Conveyor

### Description for the Open Conveyor Alternative Embodiment

In this scenario, a feeder is placing products onto an open conveyor. Instead of matching a base product on the base conveyor, we have the feeder placing the products evenly spaced on the base conveyor at a predetermined distance apart (this is referred to as the CONVEYOR_SPACING). This allows the feeder to be used to take a stack of flat products and evenly (and accurately) space them along a conveyor according to whatever distance is desired. Many industrial systems require a consistent spacing, a specific minimum spacing, or a specific maximum spacing between the products on the conveyor in order to function properly. The open conveyor embodiment fulfills this requirement using a conventional friction feeder.

This is also very useful when used along with a second feeder (using either the preferred embodiment or the speed matching embodiment) that is tipping a product onto the open conveyor products that are evenly spaced on the conveyor. Since the open conveyor products are already accurately spaced, the overall accuracy for the tipping system will increase.

Using the basic implementation of either the above-described embodiments, one can convert to an open conveyor implementation by modifying the INITIAL_B calculation. In the open conveyor implementation, the CONVEYOR_SPACING is added to INITIAL_B every time the MATCHPOINT has been reached by the conveyor product. This also removes the requirement for a sensor mounted on the conveyor.

INITIAL_{—}B=INITIAL_{—}B+CONVEYOR_SPACING

This embodiment will often be implemented with a PRODUCT_COUNT. When the system receives an external signal, the feeder will feed a number of evenly spaced products equal to the given PRODUCT_COUNT. After feeding the last product, the feeder will stop and wait for another signal or instruction. The count itself can either be set before hand (the same count every time) or it could be set on the fly based on the some input (barcode, serial input, networking input, wireless networking input, etc.).

### Fourth Alternative Embodiment

### Labeler

This embodiment uses the SECOND ALTERNATIVE EMBODIMENT (dual stage discharge) with the following modifications:

1) Instead of using a sheet feeder to feed sheets into the second stage discharge, a conventional roll-fed labeler is used (a roll of product is either cut or removed with a peel plate to individualize the product). Once individualized, the product is fed into the second stage discharge.

2) The second stage discharge in such an application would be comprised only of a top belt with vacuum. This will allow for a label with adhesive to be vacuum held to the top discharge belt, holding the non-adhesive side of the label in the up direction.

### Fifth Alternative Embodiment

### Inverted

This embodiment uses an inverted form of either the first two described embodiments to control the base conveyor instead of the feeder or labeler. Specifically, appropriate for cases where an existing machine or a constant velocity process requires that the feeder run at a constant speed or that the feeder speed cannot be controlled or altered for the purposes of tipping. In this case, the base conveyor speed and position are modified to accurately match the base product to the feeder product at the matchpoint simultaneously. In this case, the base conveyor product could be a box that the tip-on product is being fed into, rather than tipped onto.

### Sixth Alternative Embodiment

### Web

This embodiment uses either the primary or first alternative embodiment described-above with the following exception:

1) Instead of a base conveyor, the products are presented on a moving web, such as is used to make multilayer labels. In addition, it could be a backer web with adhesive upon which a sheet of paper is applied to form a label.

### Seventh Alternative Embodiment

### Multiple Products

Multiple products can be fed onto a single base product by using the following modified calculation for each product after the initial product: INITIAL_B=PREVIOUS_INITIAL_B+LEADING_EDGE_SPACING. PREVIOUS_INITIAL_B is the INITIAL_B from the previous product. LEADING_EDGE_SPACING is the spacing from the leading edge of the previous tip-on product to the leading edge of the current tip-on product.

This embodiment uses either the above-described PREFERRED EMBODIMENT or the FIRST ALTERNATIVE EMBODIMENT with the following differences:

1) Multiple tip-on products are applied to the base conveyor product in specific locations (all in one line), with the distance between products specified by the user.

The foregoing calculations have been found to result in a highly accurate tipping system that tolerates a substantial degree of non-uniform product separation between tip-on products and between base products and that can be made to operate at substantially higher speeds than traditional indexing-based tipping systems currently allow.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. Apparatus for accurately positioning tip-on product at a predetermined point on non-uniformly spaced base products as the base products are carried on a base conveyor comprising:
(a) a motor driven endless belt base conveyor having a first encoder coupled to said motor or drive for providing base conveyor positional information, said conveyor transporting base products there along,
(b) a motor driven sheet feeder for delivering individual tip-on products from a stack to a discharge conveyor of the sheet feeder where said discharge conveyor has an outlet end positioned above said endless belt of the base conveyor at a matchpoint location on the base conveyor, the motor of the motor driven sheet feeder having a second encoder for providing discharge conveyor positional information;
(c) a base product sensor positioned relative to the base conveyor for detecting the arrival of base products at a predetermined point on the base conveyor and producing a signal relating thereto;
(d) a tip-on product sensor positioned relative to the discharge conveyor for detecting the arrival of tip-on products at a predetermined point on the discharge conveyor and producing a signal relating thereto; and
(e) an electronically controlled programmable processor coupled to receive as inputs the base conveyor positional information, the discharge conveyor positional information, the signal from the base product sensor, and the signal from the tip-on product sensor, the processor being programmed for executing a PID loop routine generating a motor control signal to continuously adjust the velocity of the discharge conveyor so that the base product and the tip-on products arrive at the matchpoint location simultaneously.

2. The apparatus as in claim 1 wherein the PID loop routine receives as inputs a signal corresponding to the instantaneous position and velocity of the base conveyor and the instantaneous position and velocity of the discharge conveyor, said PID loop routine operating to diminish a positional and velocity difference between the base product and tip-on product toward zero by adjusting the speed of the motor of the motor-driven discharge conveyor as the base product and tip-on product approach the matchpoint to arrive simultaneously and at the same speed.

3. The apparatus as in claim 1 and further including a second stage discharge conveyor positioned to receive tip-on products being discharged from said discharge conveyor of the sheet feeder, the second stage discharge conveyor, rather than the discharge conveyor of the sheet feeder, having a discharge end overlaying the base conveyor at the matchpoint, a motor for driving the second stage discharge conveyor and a controller module coupled in controlling relation to said motor for driving the second stage discharge conveyor.

4. The apparatus as in claim 2 and further including a second stage discharge conveyor positioned to receive tip-on products being discharged from said discharge conveyor of the sheet feeder, the second stage discharge conveyor, rather than the discharge conveyor of the sheet feeder, having a discharge end overlaying the base conveyor at the matchpoint, a motor for driving the second stage discharge conveyor and a controller module coupled in controlling relation to said motor for driving the second stage discharge conveyor.

5. The apparatus as in claim 4 wherein the controller module comprises a programmable processor having a plurality of inputs adapted to be connected to a second base product sensor positioned relative to the base conveyor for producing an output signal upon a base product reaching a predetermined position on the base conveyor and to a second tip-on product sensor positioned relative to the second stage discharge conveyor for producing an output signal upon a tip-on product reaching a predetermined position on the second stage discharge conveyor, the controller being programmed to deliver motor control signals to the motor for driving the second stage conveyor whereby the speed of the base product and the speed of the tip-on product carried by the second stage discharge conveyor are essentially identical at the matchpoint.

6. The apparatus as in claim 5 wherein the programmable processor is programmed to execute a PID controller loop.

7. Apparatus for accurately positioning tip-on product at a predetermined point on non-uniformly spaced base products as the base products are carried on a base conveyor comprising:
(a) a motor driven endless belt base conveyor having a first encoder coupled to said motor or drive for providing base conveyor positional information, said conveyor transporting base products there along,
(b) a motor driven roll-fed labeler for delivering individual tip-on products to a discharge conveyor of the roll-fed labeler where said discharge conveyor has an outlet end positioned above said endless belt of the base conveyor at a matchpoint location on the base conveyor, the motor of the motor driven roll-fed labeler having a second encoder for providing discharge conveyor positional information;
(c) a base product sensor positioned relative to the base conveyor for detecting the arrival of base products at a predetermined point on the base conveyor and producing a signal relating thereto;
(d) a tip-on product sensor positioned relative to the discharge conveyor for detecting the arrival of tip-on products at a predetermined point on the discharge conveyor and producing a signal relating thereto; and
(e) an electronically controlled programmable processor coupled to receive as inputs the base conveyor positional information, the discharge conveyor positional information, the signal from the base product sensor, and the signal from the tip-on product sensor, the processor being programmed for executing a PID loop routine generating a motor control signal to continuously adjust the velocity of the discharge conveyor so that the base product and the tip-on products arrive at the matchpoint location simultaneously.

8. The apparatus as in claim 7 wherein the PID loop routine receives as inputs a signal corresponding to the instantaneous position and velocity of the base conveyor and the instantaneous position and velocity of the discharge conveyor, said PID loop routine operating to diminish a positional and velocity difference between the base product and tip-on product toward zero by adjusting the speed of the motor of the motor-driven discharge conveyor as the base product and tip-on product approach the matchpoint to arrive simultaneously and at the same speed.

9. The apparatus as in claim 7 and further including a second stage discharge conveyor positioned to receive tip-on products being discharged from said discharge conveyor of the roll-fed labeler, the second stage discharge conveyor, rather than the discharge conveyor of the roll-fed labeler, having a discharge end overlaying the base conveyor at the matchpoint, a motor for driving the second stage discharge conveyor and a controller module coupled in controlling relation to said motor for driving the second stage discharge conveyor.

10. The apparatus as in claim 9 wherein the controller module comprises a programmable processor having a plurality of inputs adapted to be connected to a second base product sensor positioned relative to the base conveyor for producing an output signal upon a base product reaching a predetermined position on the base conveyor and to a second tip-on product sensor positioned relative to the second stage discharge conveyor for producing an output signal upon a tip-on product reaching a predetermined position on the second stage discharge conveyor, the controller being programmed to deliver motor control signals to the motor for driving the second stage conveyor whereby the speed of the base product and the speed of the tip-on product carried by the second stage discharge conveyor are essentially identical at the matchpoint.
